(19) United States
(12) Patent Application Publication
(10) Pub. No.: US 2019/0323875 A1
(43) Pub. Date: Oct. 24, 2019

(54) ADJUSTABLE MEASURING DEVICE

(71) Applicant: Robert Moise, Plantation, FL (US)

(72) Inventor: Robert Moise, Plantation, FL (US)

(21) Appl. No.: 15/958,163

(22) Filed: Apr. 20, 2018

(51) Int. Cl. G01F 19/00; G01F 11/02

(52) U.S. Cl. CPC G01F 19/00; G01F 11/025

(57) ABSTRACT

A self-measuring adjustable measuring device comprises a central cylinder having a central chamber with at least one wall and a moveable floor. One or more adjustment elements may move the floor up or down, thereby adjusting the available volume in the central chamber. Furthermore, one or more dials or buttons may be provided and configured to manipulate the one or more adjustable elements, thereby raising or lowering the floor. The present invention may further comprise at least one spout or other liquid-directing element configured to direct the flow of the liquid or dry substances from within the central chamber to a user' desired location, such as a washing machine.

### CROSS-REFERENCE TO RELATED APPLICATION

Not applicable.

### TECHNICAL FIELD

The present invention relates generally to the field of measuring devices. More particularly, the present invention concerns a cup configured to dispense pre-measured amounts of liquid or dry ingredients.

### BACKGROUND

Liquid laundry detergent makes doing laundry easier for many persons. To utilize liquid laundry detergent, a person must pour the liquid laundry detergent into a measuring cup, then pour it from the cup into a washing machine. Needless to say, using the right amount of laundry detergent is important, so as to avoid costly waste.

Some liquid laundry detergents are more expensive than powdered laundry detergent. And, some liquid laundry detergent's viscosity can cause it to be difficult to pour properly. It is therefore not only important, but also sometimes difficult, to effectively use liquid laundry detergent. A need therefore exists for an improved self-measuring cup that enables a user to use the right amount of liquid laundry detergent.

Various attempts to meet this need have been made. For example, U.S. Patent Application Publication No. 2010/0282704, incorporated by reference in its entirety herein, generally discloses a cup configured to fit over a liquid laundry detergent bottle. While this disclosure does help a user measure the liquid laundry detergent, it unfortunately requires the user to tip over the laundry detergent bottle and perform other ungainly maneuvers.

Another attempt can be seen with respect to the disclosure of U.S. Pat. No. 6,068,165, incorporated by reference in its entirety herein, which generally discloses a self-measuring cup. Although this disclosure does provide for a measuring cup with multiple features, its hinged construction makes it susceptible to breakage or leakage.

Yet another variation on this theme can be seen with respect to U.S. Pat. No. 7,959,034, incorporated by reference herein, which generally discloses a liquid pouring and measuring assembly. While this disclosure does provide for the now-ubiquitous nesting design common in the marketplace, it still requires the user to pour the liquid to a particular line, which necessitates the problems discussed above.

Various attempts have been made to solve the problems which may be found in the related art but have thus far been unsuccessful. A need therefore exists for a new adjustable measuring device to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a spout, funnel, liquid laundry detergent, etc., are herein meant to include or encompass all equivalents for such elements. For example, in addition to a “spout”, any arcuate element, funnel or liquid-directing portion or element is also contemplated by the present invention. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention relates to an adjustable measuring device that overcomes the deficiencies of the prior art. The general purpose of the present invention, which shall be described subsequently in greater detail, is to allow a user to dispense and utilize dry or liquid substances, such as liquid laundry detergent without wasting any or using too much.

The features of the invention which are believed to be novel are particularly pointed out and distinctly claimed in the concluding portion of the specification. By way of non-limiting example, the present invention provides a novel solution for measuring and dispensing dry or liquid substances. These and other features, aspects, and advantages of the present invention will become better understood with reference to the following drawings and detailed description.

The present invention comprises an adjustable measuring device for pre-measured substances. In some embodiments, the present invention may comprise a central cylinder having a central chamber having at least one wall and a moveable floor. The present invention may provide for one or more adjustment elements that move the floor up or down, thereby adjusting the available volume in the central chamber. Furthermore, the present invention may provide for one or more dials or buttons configured to manipulate the one or more adjustable elements and thereby raise or lower the floor. The present invention may further comprise at least one spout or other liquid-directing element configured to direct the flow of the liquid laundry detergent from within the present invention into a desired location, such as but not limited to a washing machine.

More specifically, in some embodiments, the top of the present invention may comprise a spout for the user to pour out the liquid or dry substances. By way of illustration, when a bottle is connected, such as but not limited to the action of placing the present invention on the bottle's opening, and the bottle is turned upside down, the present invention may provide that a different amount of dry or liquid substance is dispensed depending on which setting dial is set. This enables a user to select how much the present invention dispenses.

In some embodiments, the present invention may comprise a universal cap and dispenser that can expand to fit different size bottles. Moreover, in some embodiments, the dial may be configured to have settings such as volumes predetermined for small, medium, large, and extra-large loads, or the applicable volumes associated with liquid or dry ingredients used in cooking or baking. Relatedly, the dial's settings may be adjustable or otherwise configured to account for concentrated measurements. As may be contemplated by those of skill in the art, the different dials and/or dial settings may be configured to automatically dispense a particular volume, and thereby allowing for precise measurements to be dispensed.

The present invention solves several problems, including but not limited to the problem of over-pouring or incorrectly measuring liquid or dry substances. Whereas some caps have to be measured by the user, in some embodiments the present invention may be configured to automatically measures the amount of the liquid or dry substance. The present invention therefore also provides benefits, such as by way of illustration, saving the user money.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

### BRIEF DESCRIPTION OF THE DRAWINGS

These and other features, aspects and advantages of the present invention will become better understood with regard to the following description, appended claims, and accompanying figures where:

FIG. 1 shows a perspective view of an adjustable measuring device in accordance with an embodiment of the invention.

FIG. 2A shows an elevational view of an adjustable measuring device in a first position in accordance with an embodiment of the invention.

FIG. 2B shows an elevational view of an adjustable measuring device in a second position in accordance with an embodiment of the invention.

FIG. 2C shows an elevational view of an adjustable measuring device in a third position in accordance with an embodiment of the invention.

FIG. 3 shows a perspective view of at least one element of an adjustable measuring device in accordance with an embodiment of the invention.

### DETAILED DESCRIPTION

The present invention overcomes the limitations of the prior art by providing a new and more effective self-cooling garment system and method of using the same.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

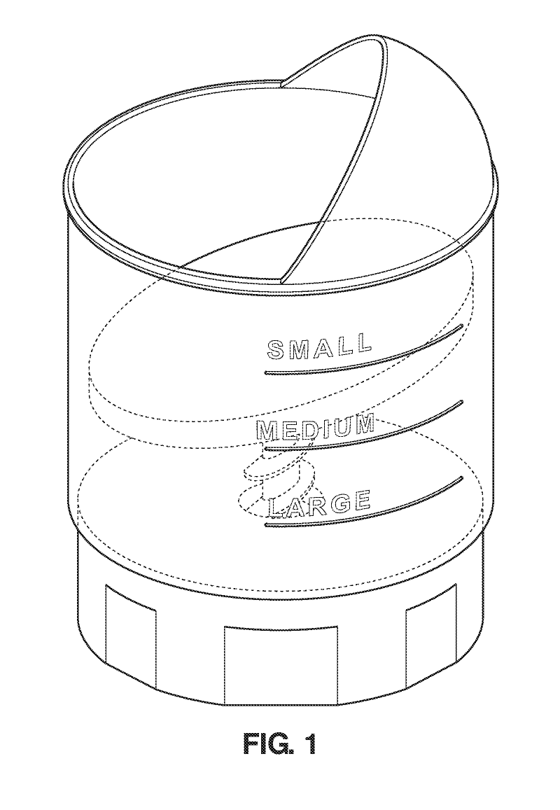

Turning attention to FIG. 1, a perspective view of an adjustable measuring device in accordance with an embodiment of the invention is shown. In the embodiment depicted, a viewer may perceive adjustable measuring device 100, main cylinder 101, spout 102, base 103, moveable floor 104, volume adjusting element 105, central cavity 106, first volume level indicator 107, second volume level indicator 108, third volume level indicator 109, and adjustment button 110.

Main cylinder 101 may be not only be configured as a cylinder as shown in FIG. 1, but in some embodiments, main cylinder 101 may be of a different shape, such as a cube, a prolate spheroid, a pyramid, or any other shape. Main cylinder may also be wider or narrower, taller or shorter, so as to accommodate different volumes of liquid or dry substances or differently-sized bottles.

Spout 102, as those of skill in the art will readily appreciate, can take any number of configurations in addition to the configuration generally disclosed in FIG. 1. For example, in some embodiments, spout 102 may be configured as a pour spout, a lip spout, an elongated spout, a narrow spout, a truncated spout, a wide spout, a funnel, a curved spout, or even a detachable spout.

Base 103 may, in some configurations, serve as a base to ground adjustable measuring device 100. In some embodiments, in addition to or alternatively, base 103 may contain one or more elements necessary to engage, manipulate, and/or move one or more other elements of the present invention, including but not limited to moveable floor 104 and volume adjusting element 105. Base 103 may also be configured to work with adjustment button 110 such that, when adjustment button 110 is pressed or engaged, in any form of adjustment button 110, base 103 is configured to move volume adjusting element 105 up or down, thereby moving moveable floor 104 up or down. In some embodiments, base 103 may be configured to twist. In embodiments wherein base 103 is configured to twist, the rotation of base 103 may cause volume adjusting element 105 up or down, thereby moving moveable floor 104 up or down.

Moveable floor 104, in some embodiments, may provide a barrier to the flow of liquid or dry substances within central cavity 106. Moveable floor 104 may therefore be configured to seal with the edges of central cavity 106. In some embodiments, such as generally shown in FIG. 1, moveable floor 104 may be angled or tilted, relative to one or more of main cylinder 101, spout 102, base 103, moveable floor 104, volume adjusting element 105, central cavity 106, first volume level indicator 107, second volume level indicator 108, third volume level indicator 109, and/or adjustment button 110. In some embodiments, therefore, the sealing edges of moveable floor 104 may be configured differently than generally shown in FIG. 1. As well, in some embodiments, moveable floor 104 may have one or more contours, protrusions, perforations, and may be thicker or thinner than generally shown in FIG. 1.

Volume adjusting element 105 is generally configured to move moveable floor up and down within main cylinder 101 and central cavity 106. In so doing, volume adjusting element 105 changes the amount of liquid or dry substances capable of containment within main cylinder 101 and central cavity 106. As discussed elsewhere herein, volume adjusting element 105 may be adjusted by a user or in some embodiments automatically via adjustment button 110, such that when adjustment button 110 is pressed or engaged, in any form of adjustment button 110, base 103 is configured to move volume adjusting element 105 up or down, thereby moving moveable floor 104 up or down. In some embodiments, adjustment button 110 may be directly connected to volume adjusting element 105. In some embodiments, volume adjusting element 105 may be configured as a spiraling adjustor, as generally shown in FIG. 1. However, in other embodiments, volume adjusting element 105 may be accordion-style, hydraulic press-style, or any other mechanism of moving an object up or down. Relatedly, in some embodiments, volume adjusting element 105 may be spring-powered, battery powered, manually adjustable, powered by a motor connected to an electrical power source, or otherwise configured to incrementally or periodically adjust the positioning of volume adjusting element 105. As used herein, periodically refers to an adjustment setting system wherein volume adjusting element 105 causes moveable floor 104 to go from level to level within the central cavity, rather than stopping at a point in-between the prescribed level.

In some embodiments, central cavity 106 may occupy all or nearly all of the space within the perimeter of main cylinder 101. However, in other embodiments, central cavity 106 may be narrower, relative to main cylinder 101, than generally disclosed in FIG. 1. As well, some embodiments of the present invention may provide for two or more central cavities 106. And, in some embodiments, central cavity 106 may provide for one or more raised portions within central cavity 106, such as but not limited to embodiments wherein one or more of first volume level indicator 107, second volume level indicator 108, and third volume level indicator 109 are disposed on the inside of central cavity 106 rather than on the outside of main cylinder 101. It is contemplated that, as used herein, central cavity 106 may occupy the area defined by the interior of main cylinder 101. Consequently, when referring to an element within central cavity 106, that element may be described in its relationship to either the interior side of main cylinder 101 or central cavity 106 interchangeably.

As may be appreciated by those of skill in the art, first volume level indicator 107, second volume level indicator 108, and third volume level indicator 109 may be disposed anywhere and in any configuration on the outside of main cylinder 101. For example, first volume level indicator 107, second volume level indicator 108, and third volume level indicator 109 may be spaced further apart from one another, or first volume level indicator 107, second volume level indicator 108, and third volume level indicator 109 may be slanted. As well, some embodiments may provide for additional or fewer volume level indicators.

Adjustment button 110 may be of any form known in the art, including but not limited to a dial. In such embodiments, the dial form of adjustment button 110 may cause volume adjusting element 105 to move up or down, thereby moving moveable floor 104 up or down. In some embodiments, adjustment button 110 may be configured as a sequential spring-loaded mechanism, whereby pressing adjustment button 110 causes volume adjusting element 105 to move up or down, thereby moving moveable floor 104 up or down, from first volume level indicator 107 to second volume level indicator 108 to third volume level indicator 109, then back to first volume level indicator 107 and so on.

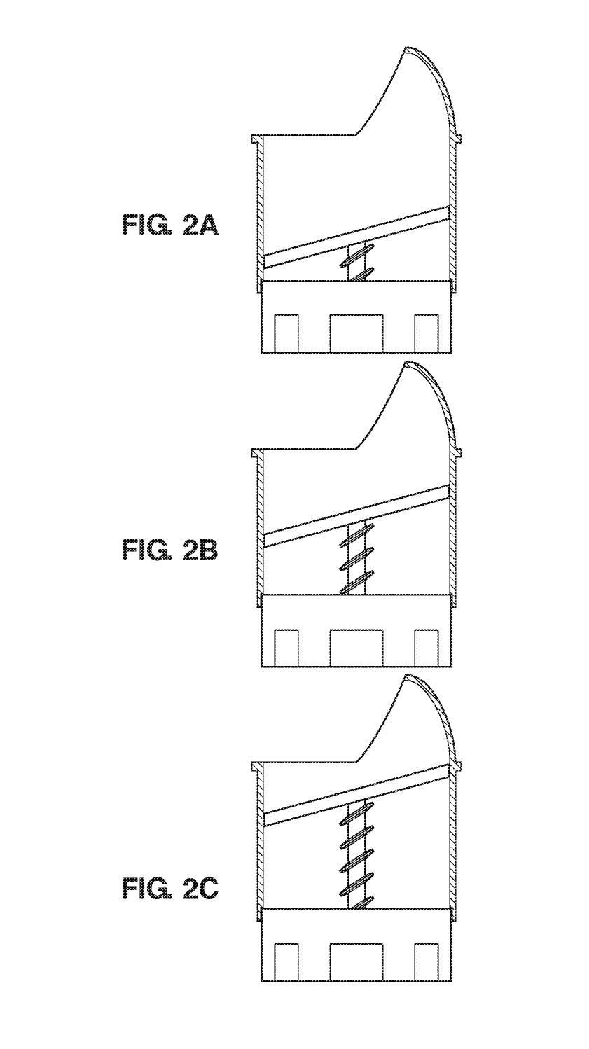

With respect to FIG. 2A, an elevational view of an adjustable measuring device in a first position in accordance with an embodiment of the invention is shown. In the embodiment depicted, a viewer may perceive adjustable measuring device 100, main cylinder 101, spout 102, base 103, moveable floor 104, volume adjusting element 105, central cavity 106, and adjustment button 110.

As may be generally seen in FIG. 2A, in a first position of adjustable measuring device 100, moveable floor 104 is in a position to receive a maximum volume of liquid or dry substances. The position of moveable floor, in some embodiments, may be the result of a user manipulating adjustment button 110, which may cause volume adjusting element 105 to move moveable floor 104 within central cavity 106.

With regards to FIG. 2B, an elevational view of an adjustable measuring device in a second position in accordance with an embodiment of the invention is shown. In the embodiment depicted, a viewer may perceive adjustable measuring device 100, main cylinder 101, spout 102, base 103, moveable floor 104, volume adjusting element 105, central cavity 106, and adjustment button 110.

As may be generally seen in FIG. 2B, in a second position of adjustable measuring device 100, moveable floor 104 is in a position to receive a medium volume of liquid or dry substances. The position of moveable floor, in some embodiments, may be the result of a user manipulating adjustment button 110, which may cause volume adjusting element 105 to move moveable floor 104 within central cavity 106.

Turning attention to FIG. 2C, an elevational view of an adjustable measuring device in a third position in accordance with an embodiment of the invention is shown. In the embodiment depicted, a viewer may perceive adjustable measuring device 100, main cylinder 101, spout 102, base 103, moveable floor 104, volume adjusting element 105, central cavity 106, and adjustment button 110.

As may be generally seen in FIG. 2C, in a first position of adjustable measuring device 100, moveable floor 104 is in a position to receive a minimum volume of liquid or dry substances. The position of moveable floor, in some embodiments, may be the result of a user manipulating adjustment button 110, which may cause volume adjusting element 105 to move moveable floor 104 within central cavity 106.

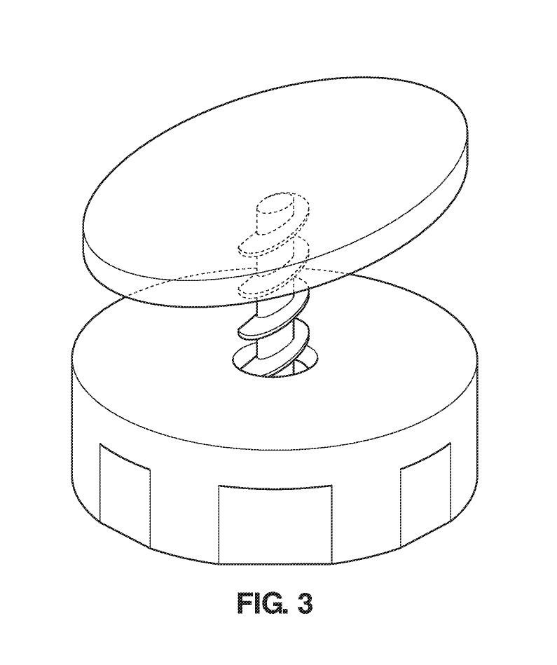

With respect to FIG. 3, a perspective view of at least one element of an adjustable measuring device in accordance with an embodiment of the invention is disclosed. In the embodiment depicted, a user may perceive base 103, moveable floor 104, and volume adjusting element 105.

As may be appreciated by those of skill in the art, FIG. 3 serves to provide a viewer with an unobstructed view of base 103, moveable floor 104, and volume adjusting element 105. Notably, the relative positions of one or more of base 103, moveable floor 104, and volume adjusting element 105 may differ in various embodiments, including but not limited to the angle of moveable floor 104 and the type of volume adjusting element 105.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention generally described herein has been disclosed in connection with a number of embodiments shown and described in detail, various modifications should be readily apparent to those of skill in the art.

What is claimed is:

1. An adjustable measuring device, comprising:
at least main cylinder having a main cylinder top side, a main cylinder bottom side, a main cylinder interior having at least one main cylinder interior side, at least one main cylinder outside, and at least one top opening disposed on the main cylinder top side;
at least one central cavity comprising the main cylinder interior side;
at least one spout disposed on the at least one top opening;
at least one base disposed on the main cylinder bottom side, wherein the at least one base has at least one base top side and at least one base bottom side;
at least one moveable floor disposed within the at least one central cavity, wherein the at least one moveable floor is configured to seal with the main cylinder interior side, and wherein the at least one moveable floor is moveable within the at least one central cavity;
at least one volume adjusting element disposed on the at least one base top side, wherein the at least one volume adjusting element is configured to move the at least one moveable floor within the at least one central cavity;
at least one adjustment button disposed on the at least one main cylinder outside, wherein the at least one adjustment button is configured to cause the at least one volume adjusting element to move within the at least one central cavity; and
at least one volume level indicator disposed on the at least one main cylinder outside.

2. The adjustable measuring device of claim 1, wherein the adjustment button is a dial.

3. The adjustable measuring device of claim 1, wherein the adjustment button is a spring-loaded mechanism.

4. The adjustable measuring device of claim 1, wherein the spout is a pour spout.

5. The adjustable measuring device of claim 1, wherein the spout is a lip spout.

6. The adjustable measuring device of claim 1, wherein the at least one volume level indicator is a small load indicator.

7. The adjustable measuring device of claim 1, wherein the at least one volume level indicator is a first volume level indicator and a second volume level indicator, wherein the first volume level indicator is a small load indicator and wherein the second volume level indicator is a medium load indicator.

8. The adjustable measuring device of claim 1, wherein the at least one volume level indicator is a first volume level indicator, a second volume level indicator, and a third volume level indicator, wherein the first volume level indicator is a small load indicator, the second volume level indicator is a medium load indicator, and the third volume level indicator is a large load indicator.

9. The adjustable measuring device of claim 8, wherein the first volume level indicator, the second volume level indicator, and the third volume level indicator are positioned at a tilted angle on the at least one main cylinder outside relative to the plane of the at least one main cylinder outside.

10. The adjustable measuring device of claim 1, wherein the at least one at least one moveable floor is angled relative to the plane of the main cylinder interior side.

11. The adjustable measuring device of claim 1, wherein the at least one volume adjusting element is configured to incrementally adjust within the at least one central cavity.

12. The adjustable measuring device of claim 1, wherein the at least one volume adjusting element is configured to periodically adjust within the at least one central cavity.
